(19) United States
(12) Patent Application Publication
(10) Pub. No.: US 2025/0351103 A1
(43) Pub. Date: Nov. 13, 2025

(54) TECHNIQUES FOR LOCAL CLOCK CALIBRATION

(71) Applicant: QUALCOMM Incorporated, San Diego, CA (US)

(72) Inventors: Ahmed Abdelaziz Ibrahim Abdelaziz ZEWAIL, San Diego, CA (US); Zhifei FAN, San Diego, CA (US); Chengjin ZHANG, San Diego, CA (US); Piyush GUPTA, Bridgewater, NJ (US)

(21) Appl. No.: 19/187,696

(22) Filed: Apr. 23, 2025

Related U.S. Application Data
(60) Provisional application No. 63/644,954, filed on May 9, 2024.

(51) Int. Cl. H04W 56/00; H04W 84/18

(52) U.S. Cl. CPC H04W 56/002; H04W 56/004; H04W 84/18

(57) ABSTRACT

Methods, systems, and devices for wireless communications are described. Techniques described herein provide for local clock calibration of an ambient internet of things (AIoT) device. In some examples, the AIoT device may receive a forward link transmission including Manchester encoded data. The AIoT device may determine whether to use the Manchester encoded data for calibration of a local clock associated with the AIoT device. The AIoT device may calibrate the local clock based on the determination. The AIoT device may transmit a backward link transmission in accordance with the calibrated local clock. In some cases, the forward link transmission may a clock calibration signal.

### CROSS REFERENCES

The present Application for Patent claims the benefit of U.S. Provisional Patent Application No. 63/644,954 by ZEWAIL et al., entitled “TECHNIQUES FOR LOCAL CLOCK CALIBRATION,” filed May 9, 2024, assigned to the assignee hereof. U.S. Provisional Patent Application No. 63/644,954 is expressly incorporated by reference herein in its entirety.

### INTRODUCTION

The following relates to wireless communications, including techniques for local clock calibration.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication performed by an ambient internet of things (AIoT) device is described. The method may include receiving a forward link transmission including Manchester encoded data, determining whether to use the Manchester encoded data for calibration of a local clock associated with the AIoT device, calibrating the local clock based on the determination, and transmitting a backward link transmission in accordance with the calibrated local clock.

An AIoT device for wireless communication performed is described. The AIoT device may include one or more memories storing processor executable code, and one or more processors coupled with the one or more memories. The one or more processors may individually or collectively be operable to execute the code to cause the AIoT device to receive a forward link transmission including Manchester encoded data, determine whether to use the Manchester encoded data for calibration of a local clock associated with the AIoT device, calibrate the local clock based on the determination, and transmit a backward link transmission in accordance with the calibrated local clock.

Another AIoT device for wireless communication performed is described. The AIoT device may include means for receiving a forward link transmission including Manchester encoded data, means for determining whether to use the Manchester encoded data for calibration of a local clock associated with the AIoT device, means for calibrating the local clock based on the determination, and means for transmitting a backward link transmission in accordance with the calibrated local clock.

A non-transitory computer-readable medium storing code for wireless communication performed is described. The code may include instructions executable by one or more processors to receive a forward link transmission including Manchester encoded data, determine whether to use the Manchester encoded data for calibration of a local clock associated with the AIoT device, calibrate the local clock based on the determination, and transmit a backward link transmission in accordance with the calibrated local clock.

In some examples of the method, AIoT devices, and non-transitory computer-readable medium described herein, the determination may be based on a length of the Manchester encoded data and calibrating the local clock further includes calibrating the local clock with the Manchester encoded data when the length of the Manchester encoded data may be greater than or equal to a threshold length.

In some examples of the method, AIoT devices, and non-transitory computer-readable medium described herein, the determination may be based on a length of the Manchester encoded data, calibrating the local clock further includes calibrating the local clock with a clock calibration signal when the length of the Manchester encoded data may be less than a threshold length, and the forward link transmission includes the clock calibration signal.

In some examples of the method, AIoT devices, and non-transitory computer-readable medium described herein, the determination may be based on the AIoT device being a backscatter modulation capable device.

In some examples of the method, AIoT devices, and non-transitory computer-readable medium described herein, the determination may be based on a timing error tolerance of the backward link transmission.

In some examples of the method, AIoT devices, and non-transitory computer-readable medium described herein, the forward link transmission includes an indication of a clock calibration signal and the determination may be based on the indication.

In some examples of the method, AIoT devices, and non-transitory computer-readable medium described herein, the forward link transmission includes a header and the header includes the indication.

Some examples of the method, AIoT devices, and non-transitory computer-readable medium described herein may further include operations, features, means, or instructions for calibrating the local clock further includes using the clock calibration signal to calibrate the local clock when the clock calibration signal may be present in the forward link transmission.

Some examples of the method, AIoT devices, and non-transitory computer-readable medium described herein may further include operations, features, means, or instructions for calibrating the local clock further includes using the Manchester encoded data or using a clock calibration signal included in the forward link transmission, based on the determination.

Some examples of the method, AIoT devices, and non-transitory computer-readable medium described herein may further include operations, features, means, or instructions for calibrating the local clock further includes comparing, during a time duration, a quantity of local clock cycles to a quantity of cycles associated with the Manchester encoded data and the time duration may be greater than a duration of one orthogonal frequency division multiplexing (OFDM) symbol associated with the forward link transmission.

Some examples of the method, AIoT devices, and non-transitory computer-readable medium described herein may further include operations, features, means, or instructions for calibrating the local clock further includes adding a time offset to the local clock based on the comparison.

A method by a network entity is described. The method may include determining to include a clock calibration signal in a forward link transmission that includes Manchester encoded data and transmit, based on the determination, the forward link transmission to an AIoT device.

A network entity is described. The network entity may include one or more memories storing processor executable code, and one or more processors coupled with the one or more memories. The one or more processors may individually or collectively be operable to execute the code to cause the network entity to determine to include a clock calibration signal in a forward link transmission that includes Manchester encoded data and transmit, based on the determination, the forward link transmission to an AIoT device.

Another network entity is described. The network entity may include means for determining to include a clock calibration signal in a forward link transmission that includes Manchester encoded data and means for transmit, based on the determination, the forward link transmission to an AIoT device.

A non-transitory computer-readable medium storing code is described. The code may include instructions executable by one or more processors to determine to include a clock calibration signal in a forward link transmission that includes Manchester encoded data and transmit, based on the determination, the forward link transmission to an AIoT device.

In some examples of the method, network entities, and non-transitory computer-readable medium described herein, the determination may be based on a length of the Manchester encoded data and determining to include the clock calibration signal further includes including the clock calibration signal when the length of the Manchester encoded data may be less than a threshold length.

In some examples of the method, network entities, and non-transitory computer-readable medium described herein, the determination may be based on the AIoT device being a backscatter modulation capable device.

In some examples of the method, network entities, and non-transitory computer-readable medium described herein, the determination may be based on a timing error tolerance of a backward link transmission that may be responsive to the forward link transmission.

In some examples of the method, network entities, and non-transitory computer-readable medium described herein, the forward link transmission includes an indication of a clock calibration signal based on the determination.

In some examples of the method, network entities, and non-transitory computer-readable medium described herein, the forward link transmission includes a header and the header includes the indication.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for local clock calibration in accordance with one or more aspects of the present disclosure.

FIG. 2 shows an example of a wireless communications system that supports techniques for local clock calibration in accordance with one or more aspects of the present disclosure.

FIG. 3 shows examples of timing diagrams that supports techniques for local clock calibration in accordance with one or more aspects of the present disclosure.

FIG. 4 shows an example of a process flow that supports techniques for local clock calibration in accordance with one or more aspects of the present disclosure.

FIGS. 5 and 6 show block diagrams of devices that support techniques for local clock calibration in accordance with one or more aspects of the present disclosure.

FIG. 7 shows a block diagram of a communications manager that supports techniques for local clock calibration in accordance with one or more aspects of the present disclosure.

FIG. 8 shows a diagram of a system including a device that supports techniques for local clock calibration in accordance with one or more aspects of the present disclosure.

FIGS. 9 and 10 show block diagrams of devices that support techniques for local clock calibration in accordance with one or more aspects of the present disclosure.

FIG. 11 shows a block diagram of a communications manager that supports techniques for local clock calibration in accordance with one or more aspects of the present disclosure.

FIG. 12 shows a diagram of a system including a device that supports techniques for local clock calibration in accordance with one or more aspects of the present disclosure.

FIGS. 13 and 14 show flowcharts illustrating methods that support techniques for local clock calibration in accordance with one or more aspects of the present disclosure.

### DETAILED DESCRIPTION

Some wireless communications systems may deploy ambient internet of things (AIoT) devices. AIoT devices may communicate with a reader device (e.g., wireless device, network entity and user equipment (UE)). The reader device may transmit a forward link transmission to the AIoT device. The AIoT device may transmit a backward link transmission in a backscatter operation on a backward link from the AIoT device to the reader device. A local clock associated with the AIoT device may have low accuracy. Due to the low local clock accuracy, the AIoT device may use external assistance with local clock calibration. In some aspects, the local clock calibration may be referred to as a clock acquisition part.

Techniques for local clock calibration at the AIoT device may provide a calibrated local clock for communication. In some examples, the AIoT device may receive a forward link transmission including Manchester encoded data. The AIoT device may determine whether to use the Manchester encoded data to calibrate a local clock. The AIoT device may calibrate the local clock based on the determination. The AIoT device may transmit a backward link transmission based on the calibrated local clock. In some cases, the AIoT device may determine to calibrate the local clock using the Manchester encoded data. The determination to use the Manchester encoded data to calibrate the local clock may be based on a length of the Manchester encoded data. In some cases, the forward link transmission may include a clock calibration signal, and the AIoT device may calibrate the local clock using the clock calibration signal.

Aspects of the disclosure are initially described in the context of wireless communications systems. Aspects of the disclosure are also described in context of timing diagrams and a process flow. Aspects of the disclosure are further illustrated by and described with reference to apparatus diagrams, system diagrams, and flowcharts that relate to techniques for local clock calibration.

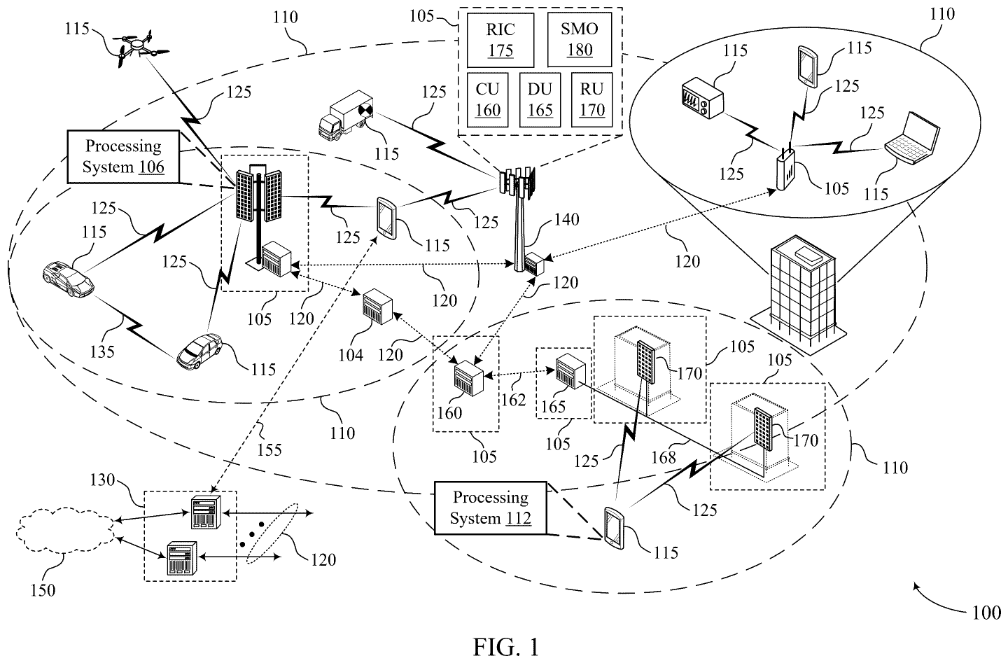

FIG. 1 shows an example of a wireless communications system 100 that supports techniques for local clock calibration in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network entity 105. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 106. Similarly, the network entity (e.g., UE 115) may include a processing system 112. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, X n, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SM O system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUS 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Some wireless communications system may deploy AIoT devices. AIoT devices may communicate with a reader device (e.g., wireless device, network entity 105 and UE 115). The reader device may transmit a forward link transmission to the AIoT device. The AIoT device may transmit a backward link (BL) transmission in a backscatter operation on a backward from the AIoT device to the reader device. A local clock associated with the AIoT device may have low accuracy. Due to the low local clock accuracy, the AIoT device may use external assistance with local clock calibration.

Techniques for local clock calibration at the AIoT device may provide a calibrated local clock for communication. In some examples, the AIoT device may receive, from a reader device (e.g., network entity 105 or UE 115) a forward link transmission including Manchester encoded data. The AIoT device may determine, based on the forward link transmission, whether to use the Manchester encoded data to calibrate a local clock. The AIoT device may calibrate a local clock based on the determination. The AIoT device may transmit a backward link transmission based on the calibrated local clock. In some cases, the AIoT device may calibrate the local clock using the Manchester encoded data. The determination to use the Manchester encoded data to calibrate the local clock may be based on a length of the Manchester encoded data. In some cases, the forward link transmission may include a clock calibration signal, and the AIoT device may determine to calibrate the location clock using the clock calibration signal.

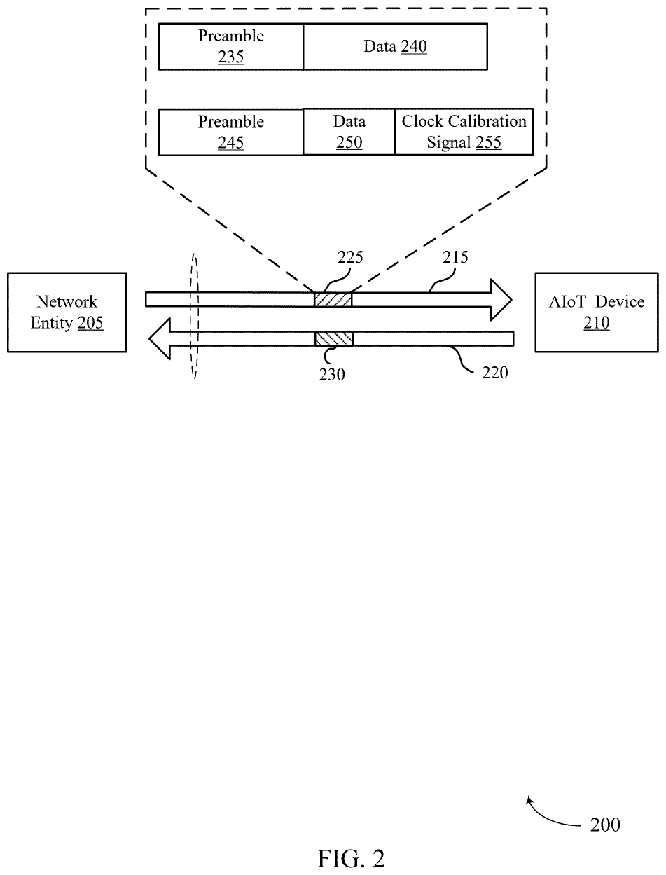

FIG. 2 shows an example of a wireless communications system 200 that supports techniques for local clock calibration in accordance with one or more aspects of the present disclosure. The wireless communications system 200 may implement aspects of or may be implemented by aspects of the wireless communications system 100. For example, the wireless communications system 200 includes a network entity 205, which may be an example of a UE 115 or a network entity 105 as described herein.

In some examples, wireless communications system 200 may include an AIoT device 210. In some cases, the AIoT device 210 may be used for inventory management or asset management inside or outside of a warehouse. The AIoT device 210 may be used as part of sustainable sensor networks in factories, logistics, smart homes, or agricultural applications. The AIoT device 210 may be used in any internet of things application. The AIoT device 210 may be a radio frequency identification (RFID) tag that includes small transponders that may emit an information bearing signal after receiving a signal. In some cases, the AIoT device 210 may operate without a battery at low operating expense (OPEX), low maintenance costs, and long life cycle. A passive AIoT device or passive RFID may harvest energy over the air and power the transmission and reception circuitry with the harvested energy. For example, the AIoT device 210 may receive power from transmissions by the network entity 205 or from the environment. In some examples, the AIoT device 210 may be a semi-passive or active RFID with a battery.

The network entity 205 may communicate with the AIoT device 210. In some examples, the network entity 205 may be RF reader (e.g., source device), such as a transmitter user equipment. For example, the network entity 205 may transmit a forward link transmission 225 on a forward link 215. With the forward link transmission, the network entity 205 may read information stored on AIoT device 210, and the network entity 205 may write information onto storage associated with the AIoT device 210. In some examples, the network entity 205 may transmit the forward link transmission 225 via a continuous waveform from the network entity 205 to the AIoT device 210, and the AIoT device 210 may harvest energy, store energy, or both from the continuous wave signal. In some cases, the AIoT device 210 may transmit a backward link transmission 230 or a signal in a backscatter operation on a backward link 220 from the AIoT device 210 to the network entity 205. The backward link transmission 230 may be a backscatter-modulated signal. The network entity 205 may read the backward link transmission 230 to decode the information transmitted by the AIoT device 210. In some cases, the AIoT device 210 may generate a signal internally that is transmitted on the backward link 220 from the AIoT device 210 to the network entity 205. Further, while wireless communications system 200 illustrates communications between the network entity 205 and the AIoT device 210, it is understood that the communications described herein may happen between any type of AIoT device 210 and any type of network entity 205 (e.g., a network entity 105, a UE 115, an access point (AP), among other examples).

In some cases, the AIoT device 210 may have a local clock that is assumed to have large error due to using low-cost technologies, and some AIoT devices may be assumed to be crystal free. The local clock of the AIoT device 210 may have an error up to 10% before calibration. In some cases, the AIoT device 210 may operate in an asynchronous mode. In some cases, the AIoT device 210 may rely on preamble detection to obtain an initial timing estimate. In some aspects, the preamble may be referred to as a start indicator part.

In some examples, the forward link transmission 225 may have a time domain frame structure including a preamble 235 and data 240. In some cases, the forward link transmission 225 may include a reader to device (R2D) timing acquisition signal included in the preamble 235 for timing acquisition by the AIoT device 210. The R2D timing acquisition signal of the preamble 235 may indicate the start of the R2D transmission (e.g., forward link transmission 225) in the time domain to the AIoT device 210. In some cases, the backward link transmission 230 may include a preamble (e.g., device to reader D2R preamble) with a D2R timing acquisition signal for timing acquisition and for indicating the start of the D2R transmission in the time domain. In some examples, the time domain frame structure of the forward link transmission 225 may include a preamble 245, data 250, and a clock calibration signal 255. Adding the signal for local clock calibration may be based on a performance requirement of the AIoT device 210, and the AIoT device 210 may use the clock calibration signal to calibrate the local clock.

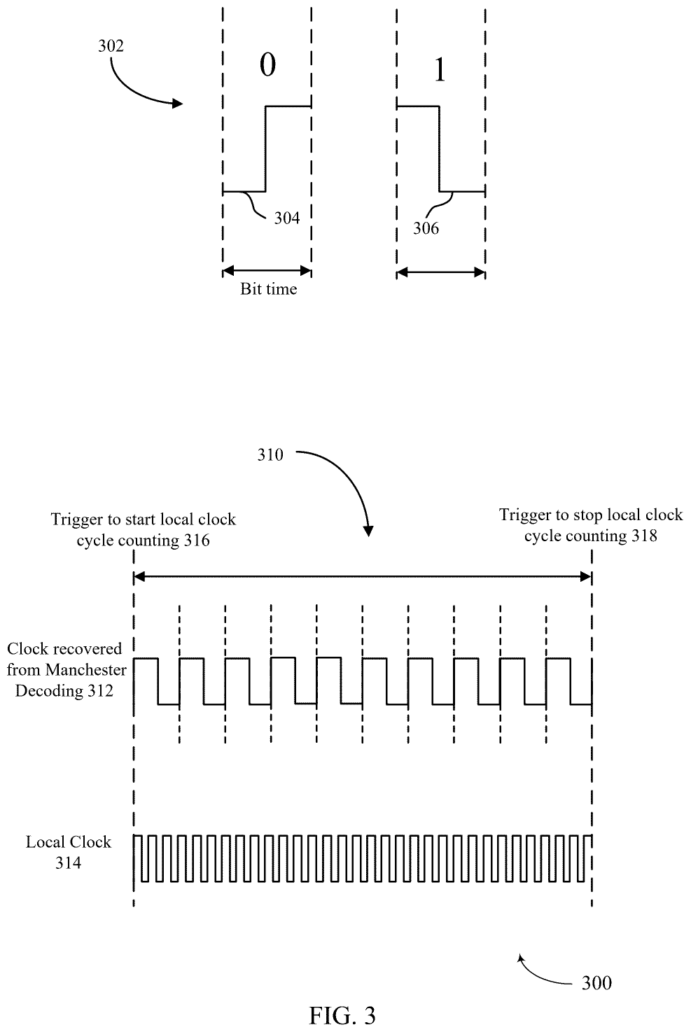

FIG. 3 shows examples of timing diagrams 300 that supports techniques for local clock calibration in accordance with one or more aspects of the present disclosure. Aspects of the timing diagrams 300 may implement, or be implemented by, aspects of wireless communications system 100 and the wireless communications system 200, or any combination thereof.

A timing diagram 302 illustrates Manchester encoded data. Manchester code may operate as a self-clocking code, seamlessly integrating clock information within the data. Manchester code employs a straightforward mechanism where each bit undergoes a transition at its midpoint. For example, a ‘0’ bit is represented by a 0 to 1 transition 304, while a ‘1’ bit is represented by a 1 to 0 transition 306. By utilizing rising and falling edge detection, the clock associated with the Manchester encoded data may be reliably recovered with the information bits. For example, Manchester encoded data may be decoded utilizing edge detection to obtain the information bits. For each detected rising or falling edge, the waveform state between half and one clock period may be inspected. If a detected transition is a rising transition and the determined state of the waveform is a low state, the output signal changes from a high state to a low state. If a detected transition is a rising transition and the determined state of the waveform is a high state, the output signal remains in its previous state. If a detected transition is a falling transition and the determined state of the waveform is a low state, the output signal again remains in its previous state. If a detected transition is a falling transition and the determined state of the waveform is a high state, the output signal changes from a low state to a high state.

In some examples, the forward link transmission 225 may cascade the preamble (e.g., the preamble 235 and the preamble 245) and Manchester encoded data (e.g., the data 240 and the data 250). The AIoT device 210 may receive the forward link transmission 225. After detecting the preamble (e.g., the preamble 235 and the preamble 245), the AIoT device 210 may achieve timing synchronization with the network entity 205 and may recognize that the Manchester encoded data follows the preamble. The AIoT device 210 may decode the Manchester encoded data and recover a clock signal as a by-product from the decoding. The AIoT device 210 may use the recovered clock signal to calibrate the local clock at the AIoT device 210. The AIoT device 210 may use the calibrated clock for the backward link transmission 230. In some cases, the recovered clock may have a limited accuracy, and the AIoT device 210 may use a dedicated clock calibration signal (e.g., clock calibration signal 255) included in the forward link transmission 225 to calibrate the local clock.

In some cases, the AIoT device 210 may use the query or the forward link transmission 225 including the Manchester encoded data (e.g., the data 240 and the data 250) to calibrate the local clock associated with the AIoT device for the backward link transmission 230. For example, the AIoT device 210 may decode the Manchester encoded data to recover the clock associated with the Manchester encoded data, and the AIoT device may calibrate the local clock using the recovered clock information from the Manchester encoded data. Depending on the length of the query or the length of the Manchester encoded data, the AIoT device 210 may calibrate the local clock using the clock recovered from the Manchester encoded data without using an additional clock calibration signal. A longer query or longer Manchester encoded data included in the forward link transmission 225 may provide higher clock calibration accuracy. For short queries or short Manchester encoded data included in the forward link transmission 225, the reader (e.g., network entity 205) may include the additional clock calibration signal following the query or the Manchester encoded data of the forward link transmission 225.

In some cases, the AIoT device 210 may determine whether to use the Manchester encoded data for calibration of a local clock associated with the AIoT device 210. In some examples, the AIoT device 210 may calibrate the local clock using the clock recovered from the Manchester encoded data when the length of the Manchester encoded data is greater than or equal to a threshold length. In some examples, the AIoT device 210 may calibrate the local clock using the clock calibration signal included in the forward link transmission 225 when the length of the Manchester encoded data is less than a threshold length.

In some cases, the reader (e.g., network entity 205) may determine whether to include the clock calibration signal in the forward link transmission 225 that includes the Manchester encoded data. In some examples, the network entity 205 may include the clock calibration signal when the length of the Manchester encoded data is less than a threshold length. In some cases, the network entity 205 may not include the clock calibration signal when the length of the Manchester encoded data is greater than or equal to a threshold length. In some examples, another factor the network entity 205 may consider when deciding to include the clock calibration signal is a AIoT device type and the uplink requirements (e.g., error tolerance of the backward link transmission 230) of the AIoT device 210. For example, a backscattering device (e.g., a backscatter modulation capable device) may tolerate higher local clock errors, and the backscattering device may utilize the Manchester encoded data for local clock calibration without the clock calibration signal. The network entity 205 may not include the clock calibration signal when transmitting the forward link transmission 225 to the AIoT device 210 that is a backscattering device or a device with error tolerance of the backward link transmission 230 greater than a threshold.

In some examples, the AIoT device 210 may determine whether or not the query or forward link transmission 225 includes the clock calibration signal. For example, the AIoT device may be hard coded to determine the presence of the clock calibration signal based on a length of the query or a length of the Manchester encoded data included in the forward link transmission 225. For example, the AIoT device 210 may determine the forward link transmission 225 includes the clock calibration signal when the length of the Manchester encoded data is less than a threshold length. In some examples, the AIoT device 210 may determine the forward link transmission 225 does not include the clock calibration signal when the length of the Manchester encoded data is greater than or equal to a threshold length. In some cases, the forward link transmission 225 may include a dynamic indication indicating the presence of the clock calibration signal. For example, the forward link transmission 225 may include a header that indicates the presence of the clock calibration signal, and the AIoT device 210 may identify the indicating in the header when determining whether the clock calibration signal is present.

In some examples, the AIoT device 210 may calibrate the local clock associated with the AIoT device 210 using the recovered Manchester clock obtained from the Manchester encoded data included in the forward link transmission 225. Referring to FIG. 3, the timing diagram 310 illustrates the clock recovered from Manchester decoding (e.g., the recovered Manchester clock 312) and the local clock 314 of the AIoT device 210. By utilizing the recovered Manchester clock 312, the AIoT device 210 may initiate a beginning and an end of local clock cycle counting. For example, the AIoT device 210 may trigger to start local clock cycle counting 316 and may count the local clock cycles and the recovered Manchester clock cycles until the trigger to stop local clock counting cycle 318. The AIoT device 210 may be aware of the symbol duration and, consequently, may anticipate the quantity of local clock cycles, facilitating calibration of any discrepancies in the local clock. For example, the AIoT device 210 may compare, during a time duration, a quantity of local clock cycles to a quantity of cycles associated with the recovered Manchester clock, and the time duration may be greater than a duration of one orthogonal frequency division multiplexing (OFDM) symbol associated with the forward link transmission 225. To calibrate the local clock, the AIoT device 210 may add a time offset to the lock clock based on the comparison of the counted quantity of local clock cycles and the counted quantity of recovered Manchester clock cycles. In some cases, a precision in counting clock errors may determine the duration or quantity of cycles for the recovered Manchester code clock. For example, a local clock may operate at a frequency of 1.92 MHz. Each OFDM symbol may have a duration of approximately 71.4 microseconds, corresponding to 137 samples when sampled at the same 1.92 MHz rate. When measuring local clock cycles over a span of 71.4 us, even a tiny fractional deviation may introduce an error of up to 0.73%, equivalent to 1/137th of a complete cycle. In some cases, a longer measurement period may be used for more precise calibration.

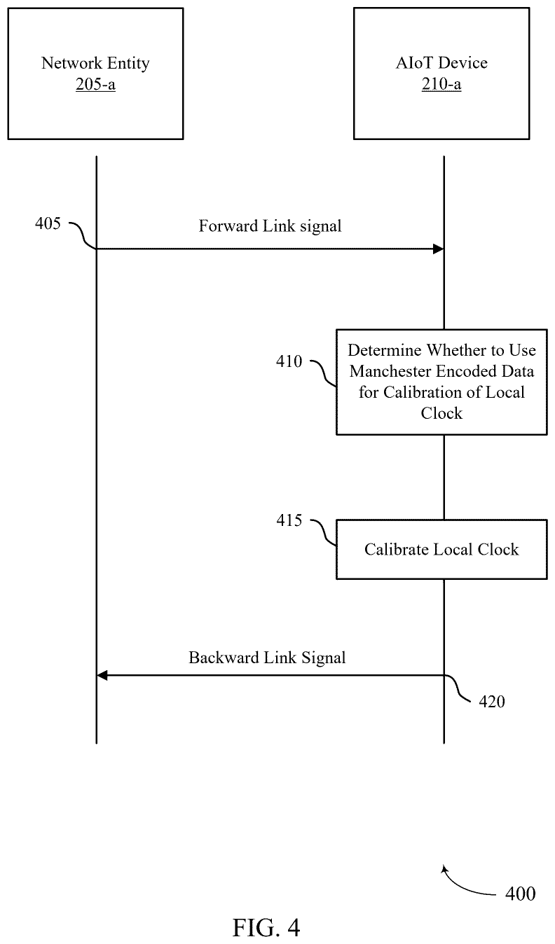

FIG. 4 shows an example of a process flow 400 that supports techniques for local clock calibration in accordance with one or more aspects of the present disclosure. In some examples, the process flow 400 may implement or be implemented by aspects of the wireless communications systems 100 and 200 as described with reference to FIGS. 1 and 2, respectively. For example, the process flow 400 may be implemented by a network entity 205-a, which may be an example of the network entity 205 as described with reference to FIG. 2. The process flow 400 may be implemented by an AIoT device 210-a, which may be an example of the AIoT device 210 as described with reference to FIG. 2.

In some examples, the operations illustrated in process flow 400 may be performed by hardware (e.g., including circuitry, processing blocks, logic components, and other components), code (e.g., software executed by a processor), or any combination thereof. Alternative examples of the following may be implemented, where some steps are performed in a different order than described or are not performed at all. In some cases, steps may include additional features not mentioned below, or further steps may be added.

At 405, the AIoT device 210-a may receive a forward link transmission including Manchester encoded data.

At 410, the AIoT device 210-a may determine whether to use the Manchester encoded data for calibration of a local clock associated with the AIoT device 210-a. In some cases, the determination may be based on a length of the Manchester encoded data. In some cases, the determination may be based on the AIoT device 210-a being a backscatter modulation capable device. In some cases, the determination may be based on a timing error tolerance of a backward link transmission.

At 415, the AIoT device 210-a may calibrate the local clock based on the determination. In some cases, the AIoT device 210-a may calibrate the local clock with the Manchester encoded data when the length of the Manchester encoded data is greater than or equal to a threshold length. In some cases, the AIoT device 210-a may calibrate the local clock with a clock calibration signal when the length of the Manchester encoded data is less than a threshold length, and the forward link transmission may include the clock calibration signal. In some cases, the forward link transmission may include an indication of a clock calibration signal, and the determination may be based on the indication. In some cases, the forward link transmission may include a header, and the header may include the indication. In some cases, the AIoT device 210-a may use the clock calibration signal to calibrate the local clock when the clock calibration signal is present in the forward link transmission. In some cases, the AIoT device 210-a may calibrate the local clock using the Manchester encoded data or the clock calibration signal included in the forward link transmission, based on the determination. In some cases, to calibrate the local clock, the AIoT device 210-a may compare, during a time duration, a quantity of local clock cycles to a quantity of cycles associated with the Manchester encoded data, and the time duration is greater than a duration of one orthogonal frequency division multiplexing (OFDM) symbol associated with the forward link transmission. In some cases, to calibrate the local clock, the AIoT device 210 may add a time offset to the local clock based on the comparison.

At 420, the AIoT device 210-a may transmit a backward link transmission in accordance with the calibrated local clock.

In some cases, prior to transmitting the forward link transmission, the network entity 205-a may determine to include the clock calibration signal in the forward link transmission that includes Manchester encoded data. In some cases, the determination to include the clock calibration signal may be based on a length of the Manchester encoded data, and the clock calibration signal is included in the forward link transmission when the length of the Manchester encoded data is less than a threshold length. In some cases, the determination to include the clock calibration signal may be based on the AIoT device 210-a being a backscatter modulation capable device. In some cases, the determination to include the clock calibration signal may be based on timing error tolerance of the backward link transmission that is responsive to the forward link transmission.

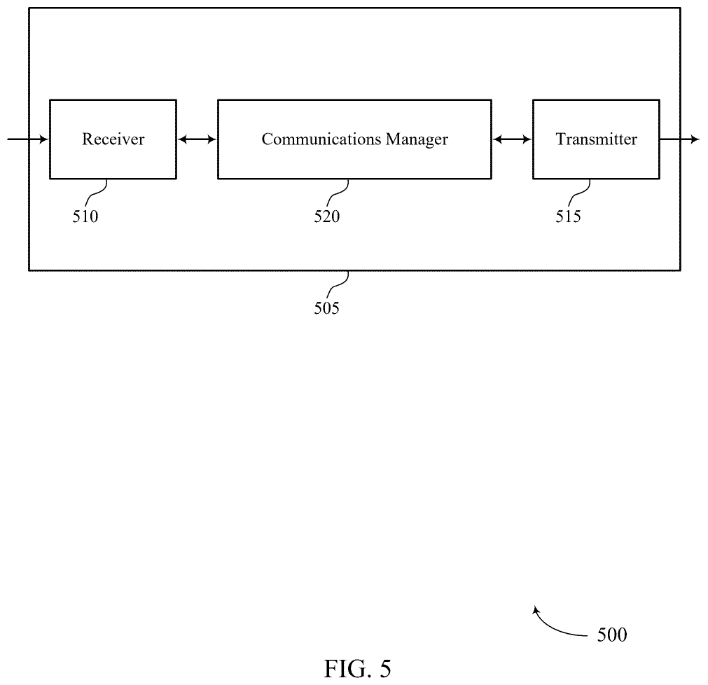

FIG. 5 shows a block diagram 500 of a device 505 that supports techniques for local clock calibration in accordance with one or more aspects of the present disclosure. The device 505 may be an example of aspects of a AIoT device 210 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for local clock calibration). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for local clock calibration). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for local clock calibration as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication performed in accordance with examples as disclosed herein. For example, the communications manager 520 is capable of, configured to, or operable to support a means for receiving a forward link transmission including Manchester encoded data. The communications manager 520 is capable of, configured to, or operable to support a means for determining whether to use the Manchester encoded data for calibration of a local clock associated with the AIoT device. The communications manager 520 is capable of, configured to, or operable to support a means for calibrating the local clock based on the determination. The communications manager 520 is capable of, configured to, or operable to support a means for transmitting a backward link transmission in accordance with the calibrated local clock.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

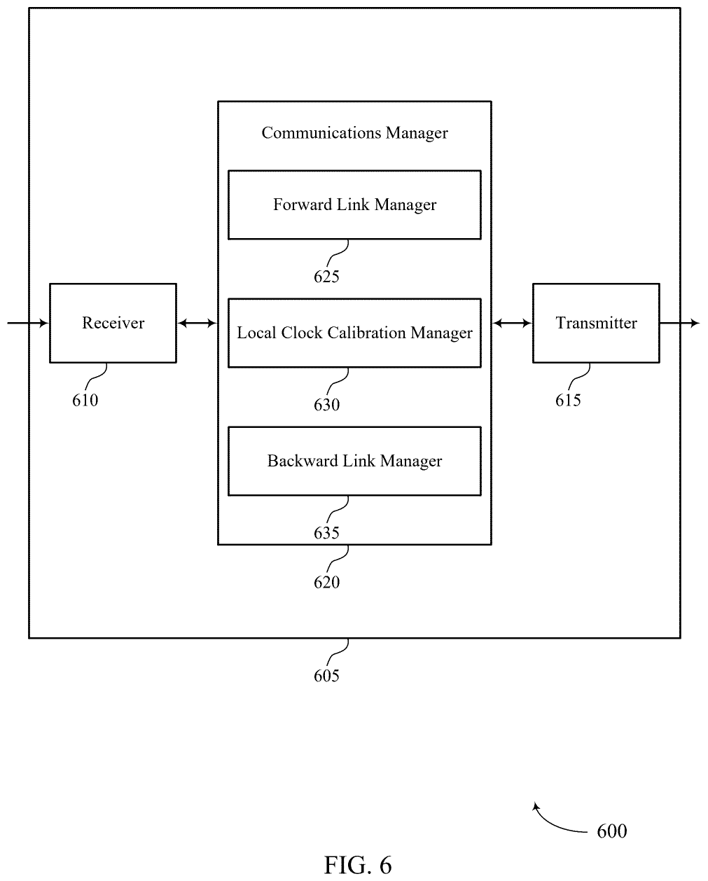

FIG. 6 shows a block diagram 600 of a device 605 that supports techniques for local clock calibration in accordance with one or more aspects of the present disclosure. The device 605 may be an example of aspects of a device 505, an AIoT device 210, or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for local clock calibration). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for local clock calibration). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for local clock calibration as described herein. For example, the communications manager 620 may include a forward link manager 625, a local clock calibration manager 630, a backward link manager 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication performed in accordance with examples as disclosed herein. The forward link manager 625 is capable of, configured to, or operable to support a means for receiving a forward link transmission including Manchester encoded data. The local clock calibration manager 630 is capable of, configured to, or operable to support a means for determining whether to use the Manchester encoded data for calibration of a local clock associated with the AIoT device. The local clock calibration manager 630 is capable of, configured to, or operable to support a means for calibrating the local clock based on the determination. The backward link manager 635 is capable of, configured to, or operable to support a means for transmitting a backward link transmission in accordance with the calibrated local clock.

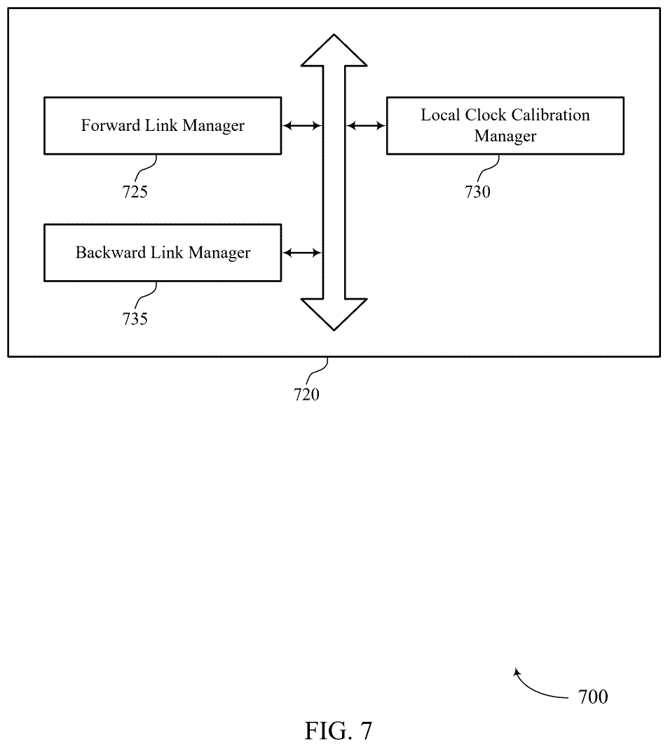

FIG. 7 shows a block diagram 700 of a communications manager 720 that supports techniques for local clock calibration in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for local clock calibration as described herein. For example, the communications manager 720 may include a forward link manager 725, a local clock calibration manager 730, a backward link manager 735, or any combination thereof. Each of these components, or components or subcomponents thereof (e.g., one or more processors, one or more memories), may communicate, directly or indirectly, with one another (e.g., via one or more buses).

The communications manager 720 may support wireless communication performed in accordance with examples as disclosed herein. The forward link manager 725 is capable of, configured to, or operable to support a means for receiving a forward link transmission including Manchester encoded data. The local clock calibration manager 730 is capable of, configured to, or operable to support a means for determining whether to use the Manchester encoded data for calibration of a local clock associated with the AIoT device. In some examples, the local clock calibration manager 730 is capable of, configured to, or operable to support a means for calibrating the local clock based on the determination. The backward link manager 735 is capable of, configured to, or operable to support a means for transmitting a backward link transmission in accordance with the calibrated local clock.

In some examples, the determination is based on a length of the Manchester encoded data. In some examples, calibrating the local clock further includes calibrating the local clock with the Manchester encoded data when the length of the Manchester encoded data is greater than or equal to a threshold length.

In some examples, the determination is based on a length of the Manchester encoded data. In some examples, calibrating the local clock further includes calibrating the local clock with a clock calibration signal when the length of the Manchester encoded data is less than a threshold length. In some examples, the forward link transmission includes the clock calibration signal.

In some examples, the determination is based on the AIoT device being a backscatter modulation capable device.

In some examples, the determination is based on a timing error tolerance of the backward link transmission.

In some examples, the forward link transmission includes an indication of a clock calibration signal. In some examples, the determination is based on the indication.

In some examples, the forward link transmission includes a header. In some examples, the header includes the indication.

In some examples, calibrating the local clock further includes using the clock calibration signal to calibrate the local clock when the clock calibration signal is present in the forward link transmission.

In some examples, calibrating the local clock further includes using the Manchester encoded data or using a clock calibration signal included in the forward link transmission, based on the determination.

In some examples, calibrating the local clock further includes comparing, during a time duration, a quantity of local clock cycles to a quantity of cycles associated with the Manchester encoded data. In some examples, the time duration is greater than a duration of one orthogonal frequency division multiplexing (OFDM) symbol associated with the forward link transmission.

In some examples, calibrating the local clock further includes adding a time offset to the local clock based on the comparison.

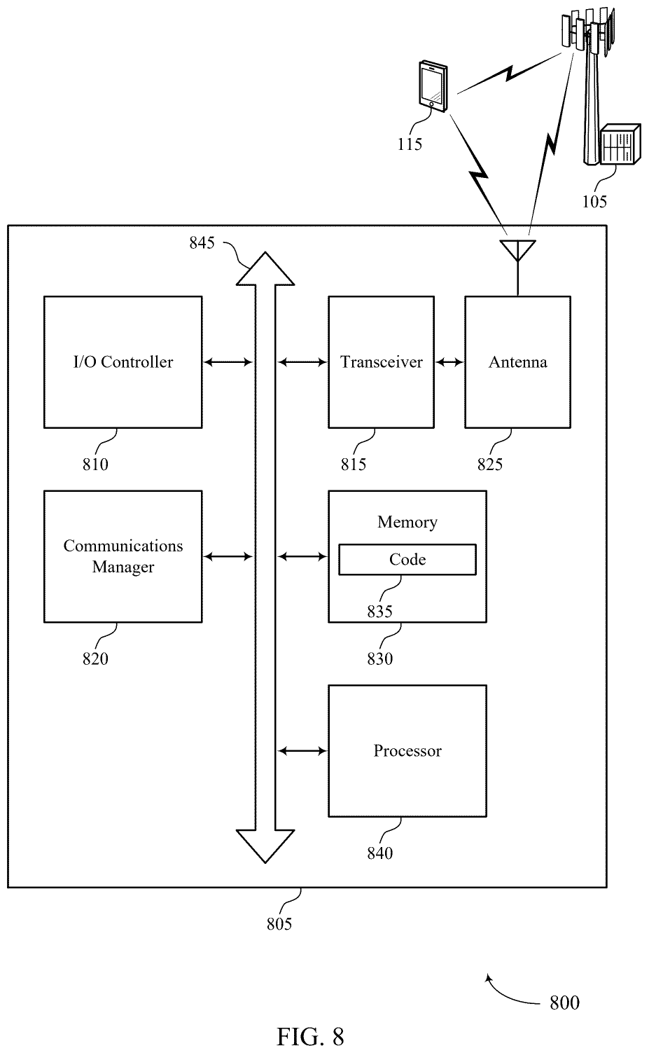

FIG. 8 shows a diagram of a system 800 including a device 805 that supports techniques for local clock calibration in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more A SICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for local clock calibration). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communication performed in accordance with examples as disclosed herein. For example, the communications manager 820 is capable of, configured to, or operable to support a means for receiving a forward link transmission including Manchester encoded data. The communications manager 820 is capable of, configured to, or operable to support a means for determining whether to use the Manchester encoded data for calibration of a local clock associated with the AIoT device. The communications manager 820 is capable of, configured to, or operable to support a means for calibrating the local clock based on the determination. The communications manager 820 is capable of, configured to, or operable to support a means for transmitting a backward link transmission in accordance with the calibrated local clock.

By including or configuring the communications manager 820 in accordance with examples as described herein, the device 805 may support techniques for improved communication reliability, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for local clock calibration as described herein, or the at least one processor 840 and the at least one memory 830 may be otherwise configured to, individually or collectively, perform or support such operations.

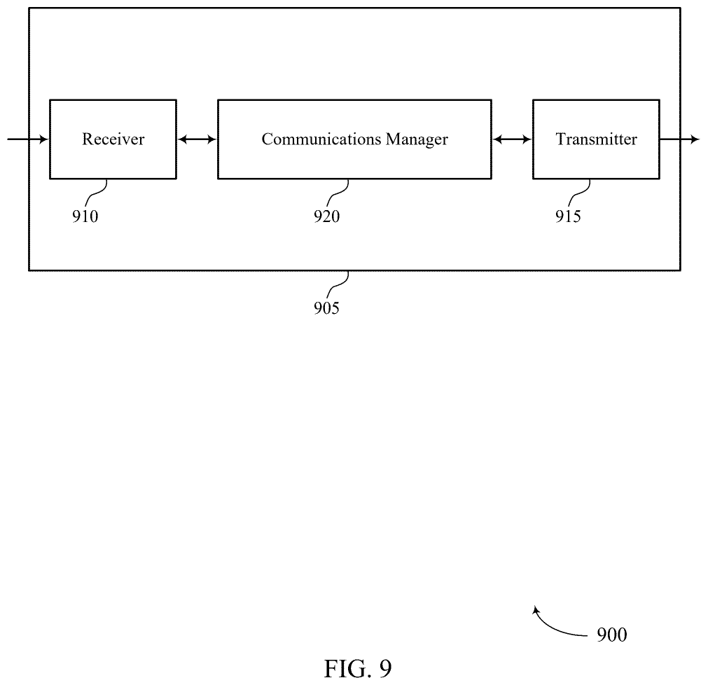

FIG. 9 shows a block diagram 900 of a device 905 that supports techniques for local clock calibration in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for local clock calibration as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 is capable of, configured to, or operable to support a means for determining to include a clock calibration signal in a forward link transmission that includes Manchester encoded data. The communications manager 920 is capable of, configured to, or operable to support a means for transmitting, based on the determination, the forward link transmission to an ambient internet of things (AIoT) device.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

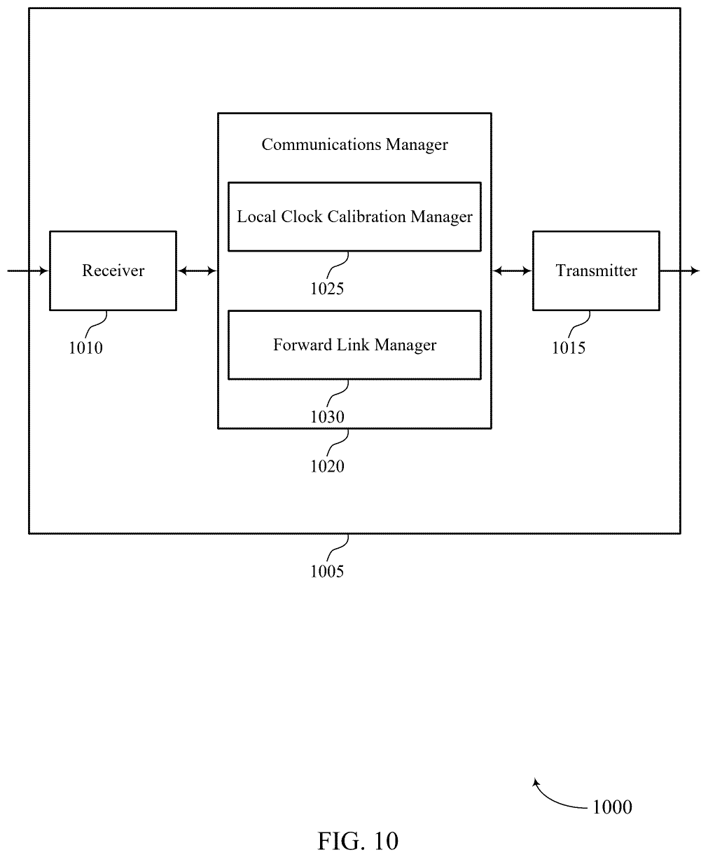

FIG. 10 shows a block diagram 1000 of a device 1005 that supports techniques for local clock calibration in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for local clock calibration as described herein. For example, the communications manager 1020 may include a local clock calibration manager 1025 a forward link manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The local clock calibration manager 1025 is capable of, configured to, or operable to support a means for determining to include a clock calibration signal in a forward link transmission that includes Manchester encoded data. The forward link manager 1030 is capable of, configured to, or operable to support a means for transmit, based on the determination, the forward link transmission to an ambient internet of things (AIoT) device.

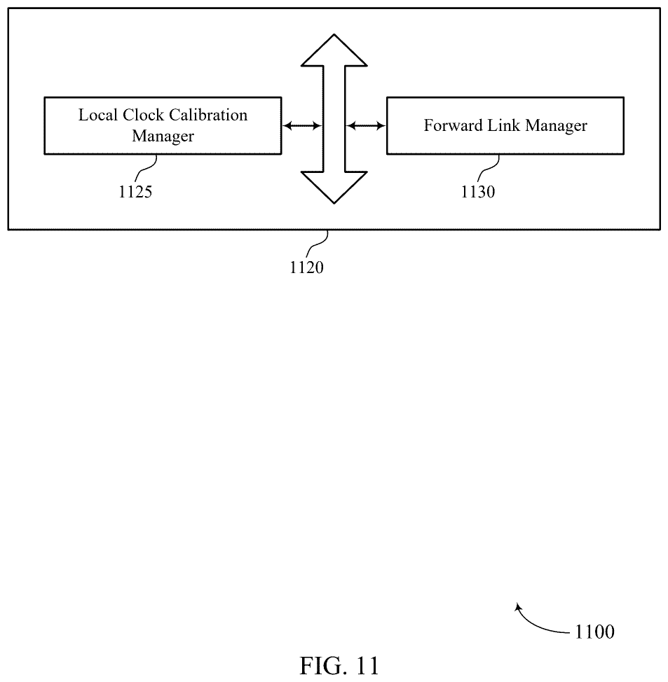

FIG. 11 shows a block diagram 1100 of a communications manager 1120 that supports techniques for local clock calibration in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for local clock calibration as described herein. For example, the communications manager 1120 may include a local clock calibration manager 1125 a forward link manager 1130, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The local clock calibration manager 1125 is capable of, configured to, or operable to support a means for determining to include a clock calibration signal in a forward link transmission that includes Manchester encoded data. The forward link manager 1130 is capable of, configured to, or operable to support a means for transmit, based on the determination, the forward link transmission to an ambient internet of things (AIoT) device.

In some examples, the determination is based on a length of the Manchester encoded data. In some examples, determining to include the clock calibration signal further includes including the clock calibration signal when the length of the Manchester encoded data is less than a threshold length.

In some examples, the determination is based on the AIoT device being a backscatter modulation capable device.

In some examples, the determination is based on a timing error tolerance of a backward link transmission that is responsive to the forward link transmission.

In some examples, the forward link transmission includes an indication of a clock calibration signal based on the determination.

In some examples, the forward link transmission includes a header. In some examples, the header includes the indication.

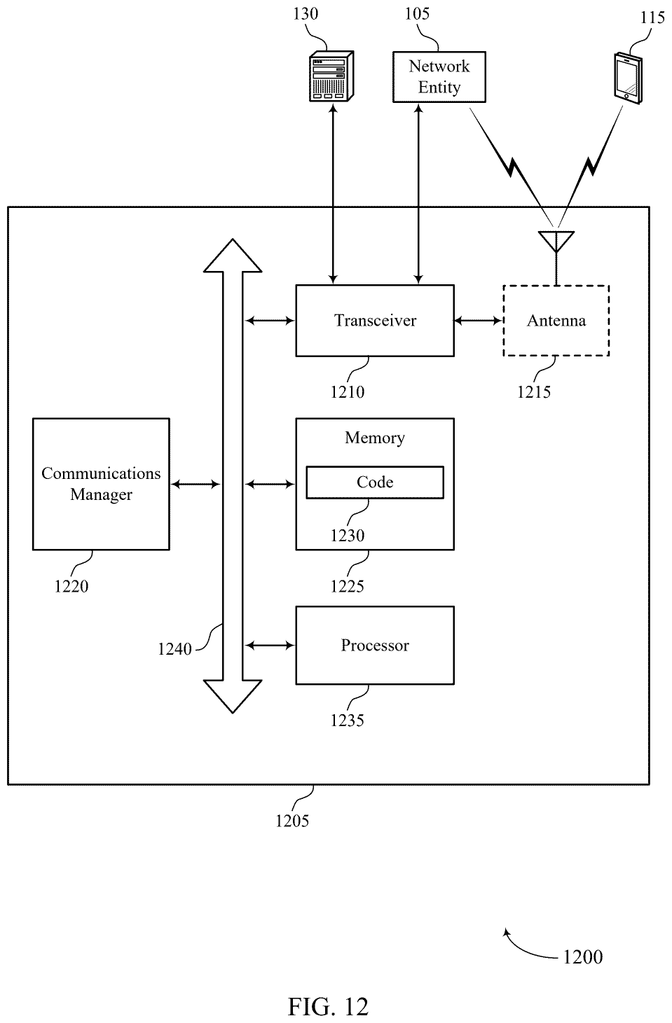

FIG. 12 shows a diagram of a system 1200 including a device 1205 that supports techniques for local clock calibration in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more A SICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for local clock calibration). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

For example, the communications manager 1220 is capable of, configured to, or operable to support a means for determining to include a clock calibration signal in a forward link transmission that includes Manchester encoded data. The communications manager 1220 is capable of, configured to, or operable to support a means for transmitting, based on the determination, the forward link transmission to an ambient internet of things (AIoT) device.

By including or configuring the communications manager 1220 in accordance with examples as described herein, the device 1205 may support techniques for improved communication reliability, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for local clock calibration as described herein, or the at least one processor 1235 and the at least one memory 1225 may be otherwise configured to, individually or collectively, perform or support such operations.

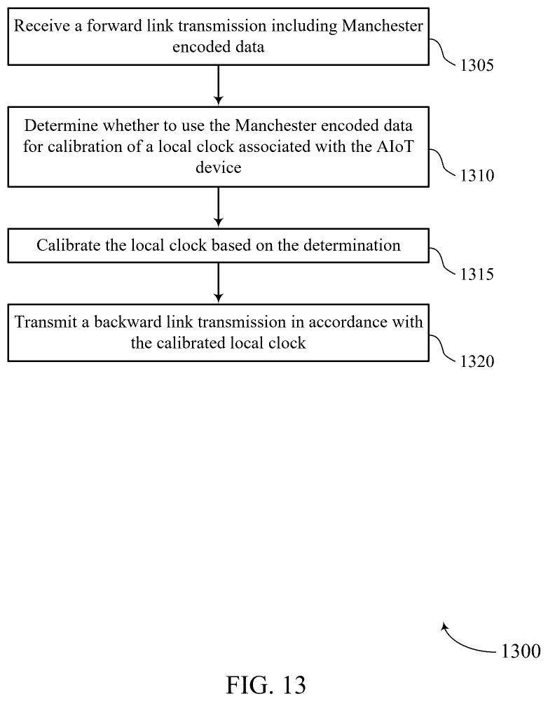

FIG. 13 shows a flowchart illustrating a method 1300 that supports techniques for local clock calibration in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a forward link transmission including Manchester encoded data. The operations of 1305 may be performed in accordance with examples as disclosed herein. In some examples, aspects of the operations of 1305 may be performed by a forward link manager 725 as described with reference to FIG. 7.

At 1310, the method may include determining whether to use the Manchester encoded data for calibration of a local clock associated with the AIoT device. The operations of 1310 may be performed in accordance with examples as disclosed herein. In some examples, aspects of the operations of 1310 may be performed by a local clock calibration manager 730 as described with reference to FIG. 7.

At 1315, the method may include calibrating the local clock based on the determination. The operations of 1315 may be performed in accordance with examples as disclosed herein. In some examples, aspects of the operations of 1315 may be performed by a local clock calibration manager 730 as described with reference to FIG. 7.

At 1320, the method may include transmitting a backward link transmission in accordance with the calibrated local clock. The operations of 1320 may be performed in accordance with examples as disclosed herein. In some examples, aspects of the operations of 1320 may be performed by a backward link manager 735 as described with reference to FIG. 7.

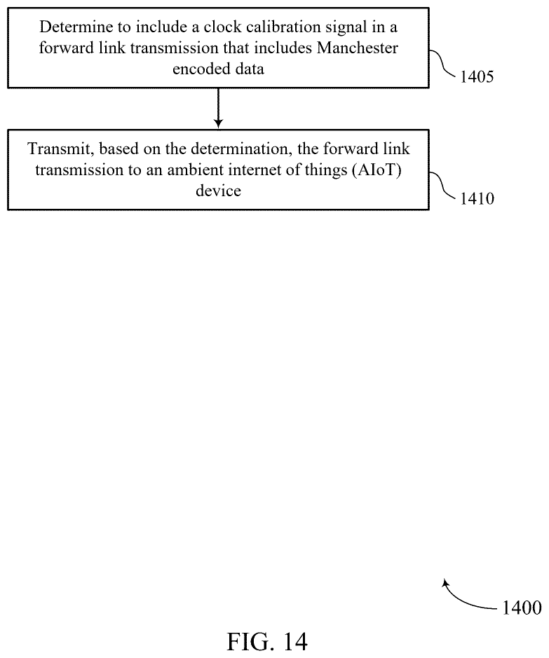

FIG. 14 shows a flowchart illustrating a method 1400 that supports techniques for local clock calibration in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include determining to include a clock calibration signal in a forward link transmission that includes Manchester encoded data. The operations of 1405 may be performed in accordance with examples as disclosed herein. In some examples, aspects of the operations of 1405 may be performed by a local clock calibration manager 1125 as described with reference to FIG. 11.

At 1410, the method may include transmit, based on the determination, the forward link transmission to an ambient internet of things (AIoT) device. The operations of 1410 may be performed in accordance with examples as disclosed herein. In some examples, aspects of the operations of 1410 may be performed by a forward link manager 1130 as described with reference to FIG. 11.

The following provides an overview of aspects of the present disclosure:

Aspect 1: A method for wireless communication performed by an AIoT device, comprising: receiving a forward link transmission including Manchester encoded data; determining whether to use the Manchester encoded data for calibration of a local clock associated with the AIoT device; calibrating the local clock based on the determination; and transmitting a backward link transmission in accordance with the calibrated local clock.

Aspect 2: The method of aspect 1, wherein the determination is based on a length of the Manchester encoded data, and calibrating the local clock further comprises calibrating the local clock with the Manchester encoded data when the length of the Manchester encoded data is greater than or equal to a threshold length.

Aspect 3: The method of aspect 1, wherein the determination is based on a length of the Manchester encoded data, calibrating the local clock further comprises calibrating the local clock with a clock calibration signal when the length of the Manchester encoded data is less than a threshold length, the forward link transmission includes the clock calibration signal.

Aspect 4: The method of aspect 1, wherein the determination is based on the AIoT device being a backscatter modulation capable device.

Aspect 5: The method of aspect 1, wherein the determination is based on a timing error tolerance of the backward link transmission.

Aspect 6: The method of any of aspect 1, wherein the forward link transmission includes an indication of a clock calibration signal, the determination is based on the indication.

Aspect 7: The method of aspect 6, wherein the forward link transmission includes a header, and the header includes the indication.

Aspect 8: The method of any of aspects 6 through 7, wherein calibrating the local clock further comprises using the clock calibration signal to calibrate the local clock when the clock calibration signal is present in the forward link transmission.

Aspect 9: The method of any of aspects 1 through 8, wherein calibrating the local clock further comprises using the Manchester encoded data or using a clock calibration signal included in the forward link transmission, based on the determination.

Aspect 10: The method of any of aspects 1 through 9, wherein calibrating the local clock further comprises comparing, during a time duration, a quantity of local clock cycles to a quantity of cycles associated with the Manchester encoded data, the time duration is greater than a duration of one orthogonal frequency division multiplexing (OFDM) symbol associated with the forward link transmission.

Aspect 11: The method of aspect 10, wherein calibrating the local clock further comprises adding a time offset to the local clock based on the comparison.

Aspect 12: A method of wireless communication performed by a network entity, comprising: determining to include a clock calibration signal in a forward link transmission that includes Manchester encoded data; and transmit, based on the determination, the forward link transmission to an AIoT device.

Aspect 13: The method of aspect 12, wherein the determination is based on a length of the Manchester encoded data, determining to include the clock calibration signal further comprises including the clock calibration signal when the length of the Manchester encoded data is less than a threshold length.

Aspect 14: The method of aspect 12, wherein the determination is based on the AIoT device being a backscatter modulation capable device.

Aspect 15: The method of aspect 12 wherein the determination is based on a timing error tolerance of a backward link transmission that is responsive to the forward link transmission.

Aspect 16: The method of any of aspects 12 through 15, wherein the forward link transmission includes an indication of a clock calibration signal based on the determination.

Aspect 17: The method of aspect 16, wherein the forward link transmission includes a header, the header includes the indication.

Aspect 18: An AIoT device for wireless communication performed, comprising one or more memories storing processor-executable code, and one or more processors coupled with the one or more memories and individually or collectively operable to execute the code to cause the AIoT device to perform a method of any of aspects 1 through 11.

Aspect 19: An AIoT device for wireless communication performed, comprising at least one means for performing a method of any of aspects 1 through 11.

Aspect 20: A non-transitory computer-readable medium storing code for wireless communications, the code comprising instructions executable by one or more processors to perform a method of any of aspects 1 through 11.

Aspect 21: A network entity comprising one or more memories storing processor-executable code, and one or more processors coupled with the one or more memories and individually or collectively operable to execute the code to cause the network entity to perform a method of any of aspects 12 through 17.

Aspect 22: A network entity comprising at least one means for performing a method of any of aspects 12 through 17.

Aspect 23: A non-transitory computer-readable medium storing code the code comprising instructions executable by one or more processors to perform a method of any of aspects 12 through 17.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UM B), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An ambient internet of things (AIoT) device for wireless communication, comprising:
a processing system configured to:
receive a forward link transmission including Manchester encoded data;
determine whether to use the Manchester encoded data for calibration of a local clock associated with the AIoT device;
calibrate the local clock based on the determination; and
transmit a backward link transmission in accordance with the calibrated local clock.

2. The AIoT device of claim 1, wherein the determination is based on a length of the Manchester encoded data, wherein the processing system is configured to calibrate the local clock with the Manchester encoded data when the length of the Manchester encoded data is greater than or equal to a threshold length.

3. The AIoT device of claim 1, wherein the determination is based on a length of the Manchester encoded data, wherein the processing system is configured to calibrate the local clock with a clock calibration signal when the length of the Manchester encoded data is less than a threshold length, wherein the forward link transmission includes the clock calibration signal.

4. The AIoT device of claim 1, wherein the determination is based on the AIoT device being a backscatter modulation capable device.

5. The AIoT device of claim 1, wherein the determination is based on a timing error tolerance of the backward link transmission.

6. The AIoT device of claim 1, wherein the forward link transmission includes an indication of a clock calibration signal, wherein the determination is based on the indication.

7. The AIoT device of claim 6, wherein the forward link transmission includes a header, and wherein the header includes the indication.

8. The AIoT device of claim 7, wherein the processing system is configured to use the clock calibration signal to calibrate the local clock when the clock calibration signal is present in the forward link transmission.

9. The AIoT device of claim 1, wherein, to calibrate the local clock, the processing system is configured to use the Manchester encoded data or to use a clock calibration signal included in the forward link transmission, based on the determination.

10. The AIoT device of claim 1, wherein, to calibrate the local clock, the processing system is configured to compare, during a time duration, a quantity of local clock cycles to a quantity of cycles associated with the Manchester encoded data, wherein the time duration is greater than a duration of one orthogonal frequency division multiplexing (OFDM) symbol associated with the forward link transmission.

11. The AIoT device of claim 10, wherein, to calibrate the local clock, the processing system is configured to add a time offset to the local clock based on the comparison.

12. A method for wireless communication performed by an ambient internet of things (AIoT) device, comprising:
receiving a forward link transmission including Manchester encoded data;
determining whether to use the Manchester encoded data for calibration of a local clock associated with the AIoT device;
calibrating the local clock based on the determination; and
transmitting a backward link transmission in accordance with the calibrated local clock.

13. The method of claim 12, wherein the determination is based on a length of the Manchester encoded data, and wherein calibrating the local clock further comprises calibrating the local clock with the Manchester encoded data when the length of the Manchester encoded data is greater than or equal to a threshold length.

14. The method of claim 12, wherein the determination is based on a length of the Manchester encoded data, wherein calibrating the local clock further comprises calibrating the local clock with a clock calibration signal when the length of the Manchester encoded data is less than a threshold length, and wherein the forward link transmission includes the clock calibration signal.

15. The method of claim 12, wherein the determination is based on the AIoT device being a backscatter modulation capable device.

16. The method of claim 12, wherein the determination is based on a timing error tolerance of the backward link transmission.

17. The method of claim 12, wherein calibrating the local clock further comprises using the Manchester encoded data or using a clock calibration signal included in the forward link transmission, based on the determination.

18. The method of claim 12, wherein calibrating the local clock further comprises comparing, during a time duration, a quantity of local clock cycles to a quantity of cycles associated with the Manchester encoded data, and wherein the time duration is greater than a duration of one orthogonal frequency division multiplexing (OFDM) symbol associated with the forward link transmission.

19. The method of claim 18, wherein calibrating the local clock further comprises adding a time offset to the local clock based on the comparison.

20. A non-transitory computer-readable medium having code for wireless communication stored thereon that, when executed by an ambient internet of things (AIoT) device, causes the AIoT device to:
receive a forward link transmission including Manchester encoded data;
determine whether to use the Manchester encoded data for calibration of a local clock associated with the AIoT device;
calibrate the local clock based on the determination; and
transmit a backward link transmission in accordance with the calibrated local clock.
